(19) United States
(12) Patent Application Publication
(10) Pub. No.: US 2003/0126734 A1
(43) Pub. Date: Jul. 10, 2003

(54) Method for manufacturing a golf club head

(76) Inventor: Hitoshi Takeda, Tsubame-shi (JP)

Correspondence Address: AKERMAN SENTERFITT, P.O. BOX 3188, WEST PALM BEACH, FL, 33402-3188, US

(21) Appl. No.: 10/287,748

(22) Filed: Nov. 4, 2002

(30) Foreign Application Priority Data
Jan. 7, 2002 (JP) 2002-831

(51) Int. Cl. B23P 13/04

(52) U.S. Cl. 29/557

(57) ABSTRACT

A method for manufacturing a golf club head which realizes the sharpening of edges of score lines even in the case that the score lines are formed by press working. Score lines 10 are formed on a face 3 by press working. Then, the face 3 is formed flat by machining process. In an alternative form of the invention, the score lines 10 are formed on the face 3 by press working, and then the face 3 is formed flat by press working process. Thus, it is possible to make the edge portion of each score line 10 flush with the surface of the face, enabling the sharpening of the edge angle thereof, so that balls are able to be easily caught on the edges, whereby there can be provided a method for manufacturing a golf club head which is able to put a spin on a ball effectively.

### BACKGROUND OF THE INVENTION

1. Field of the Invention

The present invention relates to a method for manufacturing a golf club head having score lines on a face.

2. Description of the Related Art

A face of a golf club head is formed with a plurality of grooves called score lines. Such score lines have an influence on a spinning performance of a golf club, i.e., a capability of a golf club to put a spin on a ball.

Typically, golf clubs are classified into three types, i.e., wood, iron and putter. For irons, for example, irons of small loft angles (20 to 30 degrees, for example) are called long iron, while those of large loft angles (40 to 50 degrees, for example) are called short iron. Irons are normally numbered in ascending order from the longest to the shortest such as 1st, 2nd, 3rd . . . 9th, PW, SW and etc.

Among them, particularly in the case of short irons such as PW or SW, professional players and advanced level players have a liking for those displaying high spinning performance. This is for the following reasons: The larger the loft angle becomes, the shorter distance a ball will travel, and thus a target area for golfers to carry a golf ball on will become small when using irons of large loft angles; and in such case, it is more advantageous to golfers to stop a ball near a point of fall without gaining surplus runs. Further, as green is so set that balls may roll fast thereon in a professional golf match or tournament, it is particularly necessary for such players to stop the roll of balls neat a point of fall by putting a spin thereon.

Whereas, in the manufacturing process of golf club heads according to conventional forging method, score lines have normally been formed by press working, using a die or so-called “linear die”. Such die for forming score lines is provided at its punching side with a plurality of linear bars, corresponding to the score lines, thereby forming score lines by pressing the die to the face of a golf club head, which is then polished to a final product.

In the case of forming score lines by press working, however, even a portion between adjacent score lines, which should normally be flat, is often convexly curved under the influence of plastic deformation at the time of forming the score lines. For this reason, the edges of score lines are not only depressed from a face side toward the inside of a golf club head but the angles of the edges thereof also become dull, or even rounded. Whilst a spin can be put on a ball by catching it on the edges of score lines at the time of striking the same, it is hard to put a spin if the edges of the score lines are depressed toward the inside and rounded, so that there has been a problem that golf players have found it difficult to stop a ball near the point of fall due to the shortage of spin.

### SUMMARY OF THE INVENTION

To eliminate the above problems, it is, therefore, an object of the present invention to provide a method for manufacturing a golf club which enables the sharpening of the angle of the edge of each score line even in the case that score lines are formed by press working.

According to a first aspect of the present invention, there is proposed a method for manufacturing a golf club head having a face on a front and a shaft attachment portion on one side, the method includes the steps of: forming score lines on the face by press working; and then forming the face flat by machining process.

Accordingly, as the face is formed flat by machining process, it is possible to make the edge portion of each score line flush with the surface of the face, enabling the sharpening of the edge angle thereof, so that balls are able to be easily caught on the edges, whereby there can be provided a method for manufacturing a golf club head that enables players to put a spin on a ball in an effective manner.

According to a second aspect of the invention, there is proposed a method for manufacturing a golf club head having a face on a front and a shaft attachment portion on one side, the method includes the steps of: forming score lines on the face by press working; and then forming the face flat by press working.

Accordingly, as the face is formed flat by press working, it is possible to make the edge portion of each score line flush with the face, enabling the sharpening of the edge angle of the score lines, so that balls are able to be easily caught on the edge, whereby there can be provided a method for manufacturing a golf club head which is able to put a spin on a ball in an effective manner.

### BRIEF DESCRIPTION OF THE DRAWING

For more complete understanding of the present invention, reference is now made to the following description taken in conjuncture with the accompanying drawings, in which:

FIG. 1 is a front view showing a golf club head manufactured according to an embodiment of the present invention.

FIG. 2 is a rear view showing the club head of FIG. 1.

FIG. 3 is a bottom view showing the club head of FIG. 1.

FIG. 4 is a comparative diagram for comparing sections of score lines formed according to the embodiments with those by prior art.

### DESCRIPTION OF THE PREFERRED EMBODIMENT

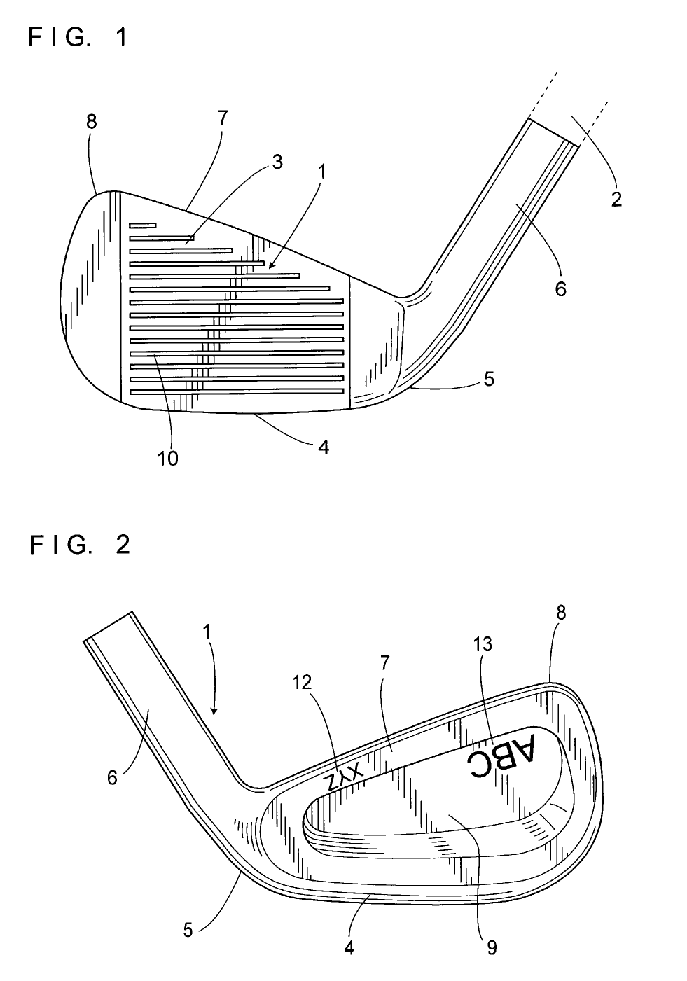

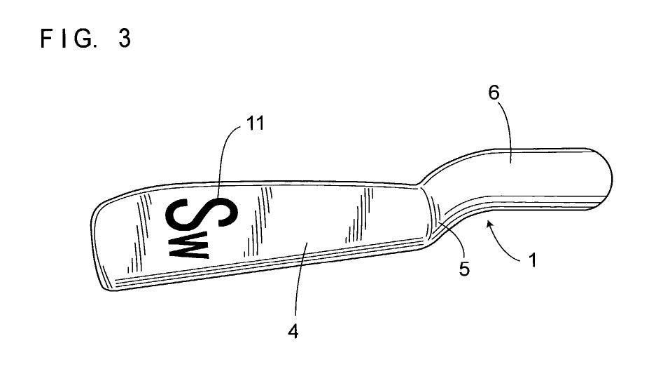

Hereunder is a description of embodiments of the present invention with reference to the accompanying drawings, in which an iron golf club is taken as an example. As shown in FIGS. 1 to 3, a golf club is made up of a head 1 and a shaft 2. The head 1 is made from a metallic material, such as low carbon steel such as S20C, stainless steel and titanium based alloy. The head 1 includes a ball-striking face 3 on a font, a sole 4 on a bottom, a heel 5 at one side, a shaft attachment portion 6 provided on an upper portion of the heel 5, said shaft attachment portion 6 being provided for connecting the shaft 2 thereto, a top 7 on a top side and a toe 8 on the other side, respectively. The rear surface of the head 1 is formed with a cavity 9, substantially opposing to said face 3.

The face 3 is formed with a plurality of score lines 10 arranged horizontally. The score lines 10 may have a V-shaped, U-shaped or trapezoidal section, which are grooves formed on a surface of the face 3, using a linear die. The sole 4 is formed with a club number display 11, which is formed on a surface of the sole 4 by press working, using a stamp. Further, the top 4 and the cavity 9 are formed with logo marks 12, 13 respectively on the rear side of the head 1 as well, said logo marks 12, 13 also being formed by press working, using a stamp.

Next, the method for manufacturing the head 1 of a first embodiment is described. At a step for preparing a material, a round bar (not shown) made of a metallic material such as low carbon steel (e.g., S20C), stainless steel or titanium based alloy is cut to a predetermined length to prepare a round bar material. Then, the round bar material is heated to form the head body through hot forging process. In the hot forging process, as it is difficult to form the head 1 at a first stroke, the forging process is divided into several steps such as rolling, preforming, intermediate forming and finish forming, so that the material of the head can be drawn into a final shape through step by step plastic deformation.

Next, burrs produced during the forging process are removed, while the head boy is subjected to a cutting process, Suitable cutting means may be chosen, such as a turning tool or a milling machine, corresponding to the configuration or design of the head 1 or the cavity 9 of a final product.

Thereafter, finishing process is carried out, which includes surface polishing; drilling for forming a hole in an axial portion of the shaft attachment portion 6, said hole for fitting the shaft 2 thereinto; reaming; and press working for forming the score lines 10, club number display 11 and logo marks 12 and 13, using a press working machine.

Whilst the score lines 10 are formed by press working, using a so-called linear die, the die is provided at its punching side with a plurality of convex bars, so that the die is pressed to the face 3 of the head 1 so as to form the score lines 10. The score lines 10 should preferably be formed to about 0.45 to 0.50 mm depth in order to comply with golfing rules. In the present embodiment, the score lines 10 are first formed to a 0.65 to 0.70 mm depth, and then the face 3 is uniformly cut by 0.2 mm by plane milling process, to thereby obtain the depth of 0.45 to 0.50 mm in the score lines 10.

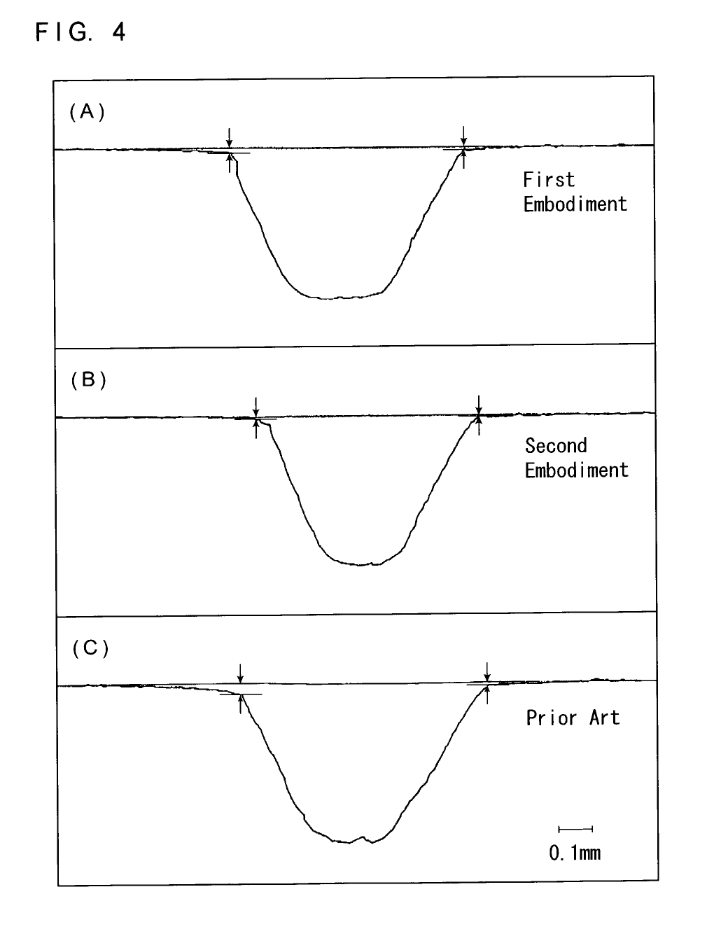

FIG. 4(A) shows a section of the face 3 taken along a line orthogonal to the score lines 10 which was subjected to such plane milling process. On the other hand, FIG. 4(C) shows that of conventional score lines 10 that was not subjected to such plane milling process, in which a portion on the face that should normally be flat is convexly curved with the edge (shown by arrow in the drawing) of each score line lying off from the surface of the face. As contrasted thereto, the section according to the embodiment shown in FIG. 4(A) indicates that the face surface 3 is flat, with the edge of each score line 10 substantially being flush with the face surface 3, defining a sharp edge.

Thereafter, the surface of the head 1 undergoes surface polishing, plating, sandblasting and coloring to thereby obtain a final product.

As is apparent from the foregoing, there is provided a method for manufacturing a golf club head having the face 3 on a front and the shaft attachment portion 6 on one side according to the foregoing embodiment, which comprises the steps of: forming the score lines 10 on the face 3 by press working; and then forming the face 3 flat by machining process.

Accordingly, as the face 3 is formed flat by machining process, it is possible to make the edge portion of each score line flush with the face 3, enabling the sharpening of the edge angle of the score lines 10, so that balls are able to be easily caught on the edge, whereby there can be provided a method for manufacturing a golf club which is able to put a spin on a ball effectively. Further, as the method of the embodiment is easily carried out by performing the machining process after conventional process, there can be provided a method for manufacturing a golf club which can provide a golf club of a high performance at low cost, enabling a player to put a spin on a ball effectively, while suppressing cost increase caused by the equipment investment or the like.

Next, a second embodiment of the invention is described. At a step for preparing a material, a round bar (not shown) made of a metallic material such as low carbon steel (e.g., S20C), stainless steel or titanium based alloy is cut to a predetermined length to prepare a round bar material. Then, the round bar material is heated to form the head body through hot forging process. In the hot forging process, as it is difficult to form the head 1 at a first stroke, the forging process is divided into several steps such as rolling, preforming, intermediate forming and finish forming, so that the material of the head can be drawn into a final shape through step by step plastic deformation.

Next, burrs produced during the forging process are removed, while the head boy is subjected to a cutting process, Suitable cutting means may be chosen, such as a turning tool or a milling machine, corresponding to the configuration or design of the head 1 or the cavity 9 of a final product as desired.

Thereafter, finishing process is carried out, which includes surface polishing; drilling for forming a hole in an axial portion of the shaft attachment portion 6, said hole for fitting the shaft 2 thereinto; reaming; and press working for forming the score lines 10, club number display 11 and logo marks 12 and 13, using a press working machine.

Whilst the score lines 10 are formed by press working, using a so-called linear die, the die is provided at its punching side with a plurality of convex bars, so that the die is pressed to the face 3 of the head 1 so as to form the score lines 10. The score lines 10 should preferably be formed to about 0.45 to 0.50 mm depth in order to comply with golfing rules. In the present embodiment, the score lines 10 are formed to the 0.45 to 0.50 mm depth by press working, and then a flat die is pressed to the face 3 to make the face 3 flat.

FIG. 4(B) shows a section of the face 3 taken along a line orthogonal to the score lines 10 which were subjected to such press working process. On the other hand, FIG. 4(C) shows that of conventional score lines 10 that were not subjected to such press working process to the face surface, in which a portion on the face that should normally be flat is convexly curved with the edge (shown by arrow in the drawing) of each score line lying off from the surface of the face. As contrasted thereto, the section according to the embodiment shown in FIG. 4(B) indicates that the face surface 3 is flat, with the edge of each score line 10 being substantially flush with the face surface 3, defining a sharp edge.

Thereafter, the surface of the head 1 undergoes surface polishing, plating, sandblasting and coloring to thereby obtain a final product.

As is apparent from the foregoing, there is provided a method for manufacturing a golf club having the face 3 on a front and the shaft attachment portion 6 on one side according to the second embodiment, which comprises the steps of: forming the score lines 10 on the face 3 by press working; and then forming the face 3 flat by press working process.

Accordingly, as the face 3 is formed flat by press working, it is possible to make the edge portion of each score line flush with the face 3, enabling the sharpening of the edge angle of the score lines 10, so that balls are able to be easily caught on the edge, whereby there can be provided a method for manufacturing a golf club head which is able to put a spin on a ball effectively. Further, as the method of the embodiment is easily carried out by performing the press working process after conventional process, there can be provided a method for manufacturing a golf club head which can provide a high performance golf club head at low cost, enabling a player to put a spin on a ball effectively, while suppressing cost increase caused by the equipment investment or the like.

Incidentally, the present invention should not be limited to the foregoing embodiments, but may be modified within the scope of the invention. For example, although the use of hot forging process is proposed as an example in the foregoing embodiments, it may be any other suitable process such as cold forging, cold pressing or casting. Alternatively, the golf club head 1 of the invention should not be limited to an iron head, but may be a metallic wood or putter.

What is claimed is:

1. A method for manufacturing a golf club head having a face on a front and a shaft attachment portion on one side, said method comprises the steps of: forming score lines on said face by press working; and then forming said face flat by machining process.

2. A method for manufacturing a golf club head having a face on a front and a shaft attachment portion on one side, said method comprises the steps of: forming score lines on said face by press working; and then forming said face flat by press working process.

3. A method for manufacturing a golf club head according to claim 1, wherein said machining process is plane milling process.

4. A method for manufacturing a golf club head according to claim 2, wherein said press working process is a process for pressing a flat die to said face.

5. A method for manufacturing a golf club head according to claim 3, wherein said score lines are first formed to a 0.65 to 0.70 mm depth, and then said face is uniformly cut by 0.2 mm by plane milling process.

6. A method for manufacturing a golf club head according to claim 4, wherein said score lines are formed to a 0.45 to 0.50 mm depth prior to said press working process.
